(19) United States
(12) Patent Application Publication
(10) Pub. No.: US 2019/0093726 A1
(43) Pub. Date: Mar. 28, 2019

(54) System for damping vibrations, damping device and method for attaching a damping device to a component

(71) Applicant: Hutchinson Stop-Choc GmbH & Co. KG, Renningen (DE)

(72) Inventor: Wladislaw Schmidt, Leonberg (DE)

(21) Appl. No.: 16/144,872

(22) Filed: Sep. 27, 2018

(30) Foreign Application Priority Data
Sep. 28, 2017 (DE) 10 2017 122 571.4

(51) Int. Cl. F16F 1/38; F16F 1/362; F16F 1/373

(52) U.S. Cl. CPC F16F 1/3849; F16F 1/362; F16F 2230/02; F16F 2230/0058; F16F 2230/0082; F16F 1/3732

(57) ABSTRACT

A system for damping vibrations has a damping device which has a fastening anchor configured to be fixed to a component. The anchor has a rod-shaped insertion element and an axial securing element projecting radially from the insertion element. The damping device has an elastic all-metal cushion having an opening dimensioned, in the unexpanded state, such that the axial securing element is not insertable through it. Part of the system is also an installation aid configured to be releasably fastened to the anchor. The installation aid is shaped in such a manner that, when it is fastened to the anchor and the cushion is pushed over the installation aid, said installation aid expands the opening of the cushion in the radial direction to such an extent that the opening of the cushion passes the axial securing element during pushing on, and the cushion latches behind the axial securing element.

### CROSS-REFERENCE TO RELATED APPLICATIONS

This application claims priority to and the benefit of German Patent Application No. 10 2017 122 571.4 filed Sep. 28, 2017 which is hereby incorporated by reference in its entirety.

### BACKGROUND OF THE INVENTION

### 1. Field of the Invention

The invention relates to a system for damping vibrations between components, in which the damping is brought about by an all-metal cushion. The invention furthermore relates to a damping device with an all-metal cushion, and to a method for attaching such a damping device to a component.

### 2. Related Art

Mechanical vibrations can be transmitted between components which are in contact or connected fixedly to one another. This is frequently undesirable since vibrations can impair the function and the service life of the components and can generate annoying noises.

In order to reduce the transmissions of vibrations between components, use is made in the art of damping devices which are arranged between the components. The damping devices frequently contain elastomers which are elastically deformed when subjected to a compressive and tensile load, but then return into their original undeformed form. Suitable elastomers can be obtained, for example, by vulcanizing natural rubber or silicone rubber. In the simplest case, such a damping device consists of an elastomer disk which is arranged between the components in such a manner that the components can be moved relative to each other counter to the resistance of the elastomer. The resistance exerted by the elastomer brings about the desired damping here; some of the vibration energy is absorbed here by the elastomer and converted into heat.

More powerful damping devices have a more complex construction. For example, EP 2 980 437 A1 discloses a damping device, in which small all-metal cushions are used instead of elastomers. All-metal cushions are understood as meaning formed parts from a knitted wire mesh that can be elastically deformed. All-metal cushions obtain the best damping properties when they are prestressed, i.e. are already compressed to a certain extent before loading by means of vibrations.

The advantage of such all-metal cushions in comparison to elastomers resides especially in the particular mechanical robustness and in the corrosion resistance to oils, grease, solvents, acids, liquids or dust. All-metal cushions retain their elastic properties in virtually unchanged form for long periods of time. Damping devices provided therewith are therefore frequently used at locations in which particularly high dynamic, thermal and chemical loads occur, e.g. in engine compartments of motor vehicles.

The damping device known from EP 2 980 437 A1 mentioned above comprises a central sleeve which is guided through a bore in a flange of a housing part. An annular damping element which contains an all-metal cushion is placed onto each of the two ends of the sleeve projecting beyond the flange. A screw is subsequently passed through the sleeve and screwed to a second component which bears against one of the two all-metal cushions. The head of the screw is supported here on the other damping element. The flange of the first component can thereby carry out vibrations in relation to the second component along the axial direction, which is predetermined by the sleeve, said vibrations being damped by the two all-metal cushions. A vibration-damped connection between the two components is thereby obtained.

A disadvantage of the known fastening system is that the two annular damping elements are only plugged loosely onto those ends of the sleeve which protrude from the flange. Only the subsequent screwing ensures that the damping elements cannot be released from the sleeve. This concept can be disadvantageous during the installation of the fastening system because it is frequently difficult for a fitter to securely hold both damping elements up to the final screwing in such a manner that they do not slide from the sleeve.

### SUMMARY OF THE INVENTION

It is therefore an embodiment of the invention to simplify the attaching of a damping device to a component.

The embodiment is achieved by a system for damping vibrations, which includes a damping device which comprises a fastening anchor which is fixable to a component. The fastening anchor has a rod-shaped insertion element and an axial securing element which projects radially from the insertion element. Furthermore, the damping device comprises an elastic all-metal cushion which has an opening which, in the unexpanded state, is dimensioned in such a manner that the axial securing element is not insertable through it. In addition, the system includes an installation aid which can be plugged in on the fastening anchor or fastened releasably in some other way to the fastening anchor. The installation aid is shaped in such a manner that, when it is fastened to the fastening anchor and the all-metal cushion is pushed over the installation aid, said installation aid expands the opening of the all-metal cushion in the radial direction to such an extent that the opening in the all-metal cushion passes the axial securing element during pushing on, and the all-metal cushion latches behind the axial securing element.

The axial securing element ensures that the all-metal cushion is secured axially after the latching and, as a result, can no longer be unintentionally released from the fastening anchor. The attaching of the damping device to the component is thereby considerably facilitated since the damping device no longer has to be fixed with the hands until it is in its final fitted position.

The axial securing element is preferably arranged on the insertion element in such a manner that the all-metal cushion is already prestressed in the axial direction after the latching. Axial prestressing is advantageous if a good damping effect is intended to be obtained even in the event of small vibration amplitudes.

The installation aid, which is only fastened temporarily to the fastening anchor in order to facilitate the expansion of the all-metal cushion, is generally released again from the fastening anchor after the expansion and can be reused.

In one embodiment, the axial securing element is formed by a step on a circumferential surface of the insertion element. The step can run completely there around, but can also be interrupted at one or more points. It is particularly advantageous if such a step is located at one end of the insertion element and thereby forms a collar (optionally interrupted once or more than once). The insertion element then no longer projects beyond the all-metal cushion after the latching. In particular, the collar together with the all-metal cushion can form a contact surface against which a screw head or a further component can lie.

Damping devices of the type according to embodiments of the invention are generally used in such a manner that an all-metal cushion, between which the component is arranged, is located at each end of the insertion element. It is therefore expedient if an axial securing element projects in the radial direction at each end of the insertion element.

It is particularly simple if the axial securing element is formed integrally on the insertion element. However, the axial securing element can also be in the form of a separate component which is fastened to the insertion element. For example, the axial securing element can be in the form of a snap-action ring which latches in an encircling annular groove on an outer surface of the insertion element. It is also possible to form the axial securing element by means of a short pin which is pressed into a radial bore in the insertion element.

In one embodiment, the insertion element is a sleeve, the cross section of which is preferably, but does not inevitably have to be, circular. A sleeve-shaped insertion element is expedient if the installation aid has a cylindrical portion which, for the purpose of releasably fastening the installation aid to the fastening anchor, is insertable into the sleeve with a transition fit having a small excess size. The installation aid can thereby be fastened to the fastening anchor, and removed again after the all-metal cushion is pushed on, particularly easily by hand or using a pair of pincers.

If the system also includes a screw or another fastening element, this can be guided through the sleeve and fastened to a further component, as is known per se in the prior art.

In the case of insertion elements which are not sleeve-shaped, a recess into which the installation aid can be plugged can be provided on the end side.

In one embodiment, in order to expand the opening of the all-metal cushion, the installation aid has a portion having a cross section which increases in a longitudinal direction of the installation aid. When the all-metal cushion is pushed on over said portion, the opening expands in the desired manner as a result of the increasing cross section of the installation aid projecting into the opening. The portion can be in particular conical, but in an individual case deviations from a conical shape may also be expedient.

In one embodiment, the all-metal cushion is surrounded by at least one holder element which partially engages around the all-metal cushion. Such a holder element protects the all-metal cushion against external influences, assists the shape retention of the all-metal cushion and, in addition, brings about a better distribution of the forces over and beyond the axial surfaces of the all-metal cushion.

So that the all-metal cushion can be compressed in the axial direction, it is expedient if the all-metal cushion is surrounded by a first and by a second holder element, which holder elements are spaced apart from each other in an axial direction and engage around the all-metal cushion in each case in the radial direction and from above or from below, as is known per se in the prior art.

In one embodiment, the all-metal cushion has the form of a rotation body which is obtained by rotation of a surface about an axis which lies in the plane of the surface, but does not intersect said plane. In particular, the surface can be approximately rectangular. If the bore in the component, into which the insertion element is inserted, does not have a round cross section, but rather a different cross section (e.g. square), it may be expedient to provide the installation aid and also the all-metal cushion with a shape matched to the cross section of the bore.

An embodiment of the invention also relates to a damping device which is part of the above-explained system. The damping device has a fastening anchor which is fixable to a component and has a rod-shaped insertion element and an axial securing element which projects radially from the insertion element. In addition, the damping device comprises an elastic all-metal cushion which has an opening which, in the unexpanded state, is dimensioned in such a manner that the axial securing element is not insertable through it. The opening of the all-metal cushion is expandable in the radial direction with the aid of an installation aid to such an extent that the opening in the all-metal cushion passes the axial securing element during pushing on, and the all-metal cushion latches behind the axial securing element.

The embodiment mentioned at the beginning is also achieved by a method for attaching a damping device to a component, which method has the following steps:
a) a damping device is provided, which comprises an elastic all-metal cushion, which has an opening, and a fastening anchor which has a rod-shaped insertion element and an axial securing element which projects radially from the rod-shaped insertion element;
b) an installation aid is fastened releasably to a first end of the fastening anchor;
c) the all-metal cushion is pushed with the opening over the installation aid, as a result of which the opening of the all-metal cushion is expanded in the radial direction to such an extent that the opening passes the axial securing element and latches the all-metal cushion behind the axial securing element;
d) at any time after step a), the insertion element is inserted into a bore in the component, the diameter of which bore is smaller than the outer diameter of the all-metal cushion.

As has already been explained above, the axial securing element, to which the all-metal cushion can latch, facilitates the attaching of the damping device.

The bore in the component is preferably a through-bore, the length of which is smaller than the length of the insertion element. After step d), steps b) and c) can be repeated at the other end of the fastening anchor, with the use of a further elastic all-metal cushion, as a result of which the first component is surrounded by the two all-metal cushions.

It is also advantageous here if the insertion element is a sleeve. A screw or another fastening element can then be passed through the sleeve and fastened to the second component.

### BRIEF DESCRIPTION OF DRAWINGS

Embodiments of the invention will be explained in more detail below with reference to the drawings, in which:

FIGS. 1 to 10 show a damping device according to the invention according to a first embodiment in an axial section during various phases when fastening the damping device between two components;

FIG. 11 shows the damping device, which is shown in FIGS. 1 to 10, and the installation aid in a perspective illustration;

FIG. 12 shows a damping device according to the invention according to a second embodiment in an axial section;

FIG. 13 shows the damping device, which is shown in FIG. 12, in the fitted state.

### DETAILED DESCRIPTION OF THE EMBODIMENTS

### 1. First Embodiment

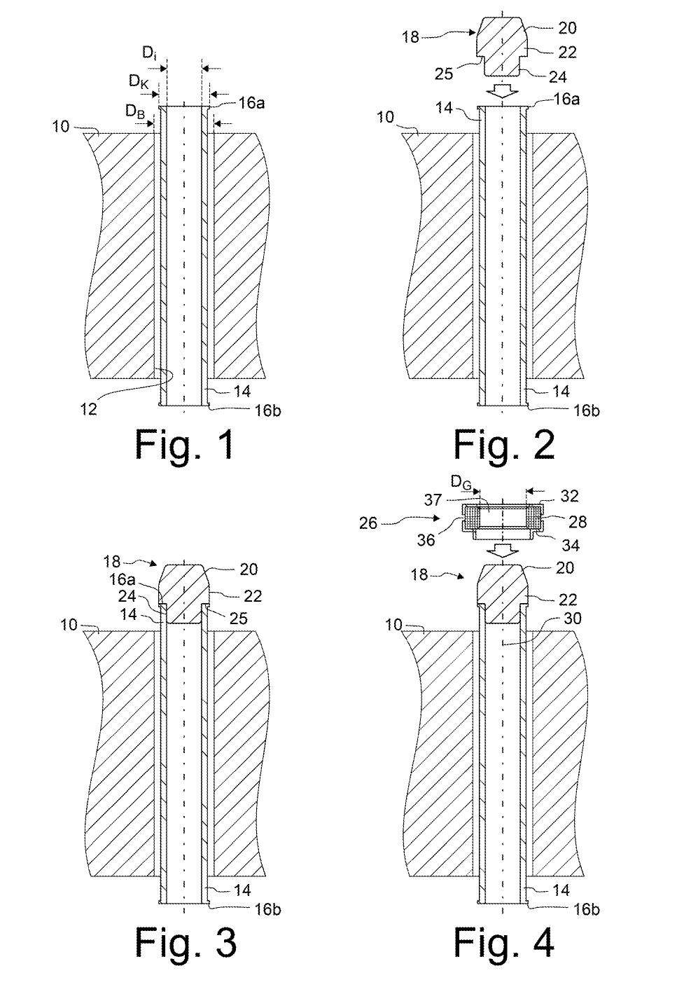

FIG. 1 shows, in an axial section, part of a flange 10 that belongs to a first component which is intended to be connected in a vibration-damped manner to a second component. The flange 10 is provided with a cylindrical through-bore 12 which has a diameter D_{B}. In the embodiment illustrated, the insertion element is a cylindrical sleeve 14 which has an encircling collar 16a and 16b at each of its opposite ends. The collar 16a, 16b projects in the radial direction from the cylindrical outer surface of the sleeve 14 and has an outer diameter D_{K} which is smaller than the diameter D_{B} of the through-bore 12. The insertion element can thereby be passed completely through the through-bore 12, as can be seen in FIG. 1.

An installation aid 18, which, in the embodiment illustrated, has a conical portion 20, a first cylindrical portion 22 and a second cylindrical portion 24, can be seen above the sleeve 14 in FIG. 2. In the embodiment illustrated, the diameter of the first cylindrical portion 22 is equal to the outer diameter D_{K} of the collar 16a. The diameter of the second cylindrical portion 24 is smaller than the diameter of the first cylindrical portion 22 and slightly smaller than the inner diameter D₁, which is shown in FIG. 1, of the sleeve 14. The installation aid 18 can therefore be introduced with its second cylindrical portion 24 into the upper end of the sleeve 14 in the direction indicated with an arrow. The diameter of the second cylindrical portion 24 is coordinated here with the inner diameter Dᵢ of the sleeve 14 in such a manner that the installation aid 18 is insertable into the sleeve with a transition fit having a small excess size. Ideally, the second portion 24 of the installation aid 18 can therefore be inserted into the sleeve 14 by hand, is held securely there and can be released again from the sleeve 14 later, likewise by hand, by pulling on the installation aid 18.

FIG. 3 shows the installation aid 18 after its fastening to the upper end of the sleeve 14. An encircling shoulder 25, which is formed between the two cylindrical portions 22, 24 of the installation aid 18, rests flat here on the encircling collar 16a of the sleeve 14, and therefore the installation aid cannot be completely inserted into the sleeve, but rather projects with its conical portion 20 and the first cylindrical portion 22 over the sleeve 14. The first cylindrical portion 22 is aligned with the outer surface of the collar 16a.

In a next step, a damping element 26 is pushed on over the installation aid 18, as FIG. 4 illustrates. The damping element 26 has an all-metal cushion 28 which is substantially annular in the embodiment illustrated. As can be seen in the enlarged detail A of FIG. 8, the all-metal cushion 28 has the form of a rotation body which is obtained by rotation of a rectangular surface about the axis of symmetry 30, which lies in the plane of the surface, but does not intersect said plane. The all-metal cushion 28 is surrounded from the top and from the bottom by first and second plate-like holder elements 32, 34, said holder elements being spaced apart from each other in the axial direction. The two holder elements 32, 34 in each case engage around the all-metal cushion 28 in the radial direction and from the top and from the bottom. As can best be seen in the enlarged illustration of FIG. 8, the first holder element 32 is substantially annular and has a single angle. The second holder element 34 is likewise annular, but has two angles. Owing to the encircling gap 36 between the holder elements 32, 34, the all-metal cushion 28 arranged therebetween can be compressed in the axial direction without the holder elements 32, 34 butting against each other at their encircling, angled ends. The holder elements 32, 34 are connected nonreleasably by spot welding to the all-metal cushion 28 and, together with the latter, form a unit which can be comfortably handled during the installation.

The central openings in the holder elements 32, 34 have a diameter which is somewhat larger than the outer diameter of the collar 16a, 16b. However, this does not apply to the all-metal cushion 28. In the unexpanded state, the opening 37 of the all-metal cushion has an inner diameter D_{G} which, in the embodiment illustrated, is as large as the outer diameter of the sleeve 14, but is somewhat smaller than the outer diameter D_{K} of the collar 16a. The damping element 26 together with the all-metal cushion 28 therefore cannot be readily pushed on over the collar 16a of the sleeve 14.

However, the damping element 26 can be pushed over the collar 16a when the opening 37 is expanded with the use of the installation aid 18, as is illustrated in FIG. 5. When, during the pushing of the damping element 26 onto the installation aid 18, the all-metal cushion 28 in the region of the conical portion 20 touches the installation aid 18, as FIG. 5 shows, the all-metal cushion 28 is compressed in the radial direction by the conical portion 20 during further pushing on and, in the process, the opening 37 is expanded. By means of slight pressure, the damping element 26 can therefore be pushed over the conical portion 20 of the installation aid 18 counter to the resistance of the all-metal cushion 28, which is compressed in the radial direction, until the damping element 26 is located on the first cylindrical portion 22 of the installation aid 18, as FIG. 6 shows. The opening 37 is then expanded to a maximum.

The all-metal cushion 28 is then pushed downward further over the first cylindrical portion 22 and the upper collar 16a until the all-metal cushion 28 latches behind the encircling collar 16a, as FIG. 7 and the enlarged detail A therefrom according to FIG. 8 show. A narrow annular region of the upper axial surface of the all-metal cushion 28 then lies against an encircling step 40 of width b, which is formed by the collar 16a. As a result of the latching, the damping element 26 can now no longer be readily pulled off upward.

The damping element 26 is now located between the flange 10 and the collar 16a of the sleeve 14 and can be braced there when required.

In the next step, the installation aid 18 is preferably pulled off from the sleeve 14.

The above-described operation is then repeated with the second damping element 26′ on the downwardly facing side of the sleeve 14. FIG. 9 shows the above-described arrangement after the attaching of the second damping element 26′, before the installation aid 18 is pulled off downward. A damping device 41 consisting of the sleeve 14 and two damping elements 26, 26′ is now fastened to the flange 10 and can be used to connect the flange 10 of the first component to a second component.

Such a connection is illustrated in FIG. 10. A screw 42, the threaded portion 44 of which is screwed into a threaded bore 46 of the second component 48, is guided through the sleeve 14 of the damping device 41. The flange 10 of the first component can then carry out vibrations in the axial direction between the second component 48 and a head 50 of the screw 42, said vibrations being damped by the damping elements 26, 26′. At the same time, the screwing prestresses the all-metal cushions 28 of the two damping element 26, 26′.

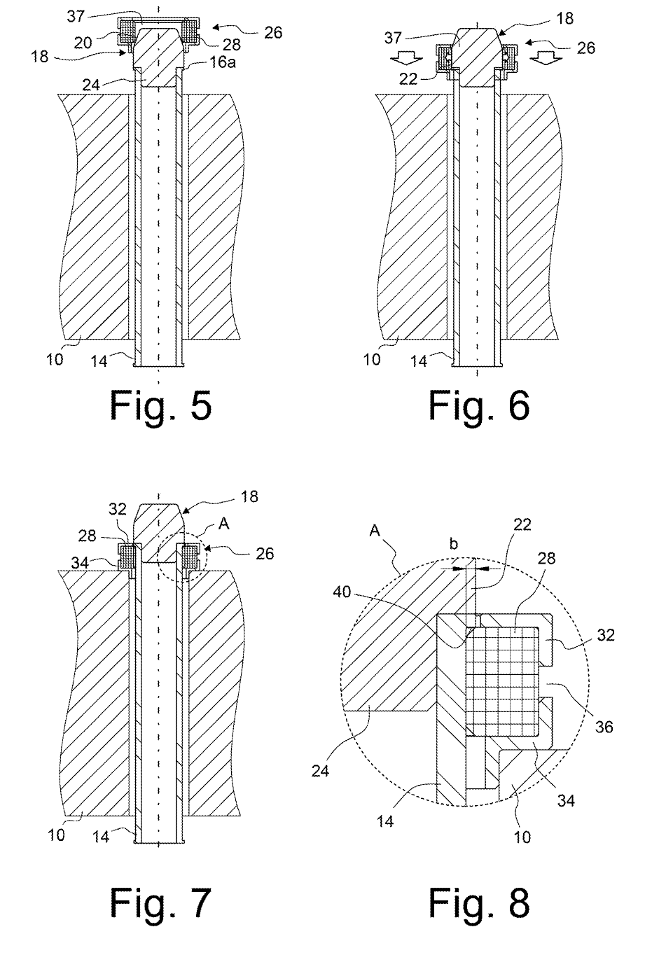

FIG. 11 shows the damping device 41 without a flange 10 in a perspective illustration after the installation aid 18 has been pulled off.

It has been described above with reference to FIGS. 1 to 8 that first of all the sleeve 14 is inserted into the through-bore 12 of the flange 10 and then the damping element 26 is pushed over the collar 16a of the sleeve 14 with the use of the installation aid 18. As an alternative thereto, the operation can also be carried out in a reverse sequence. In this case, first of all the damping element 26 is attached to the sleeve 14 and subsequently the sleeve 14 is introduced into the through-bore 12 from the opposite side. In both cases, the arrangement shown in FIG. 7 is obtained.

### 2. Second Embodiment

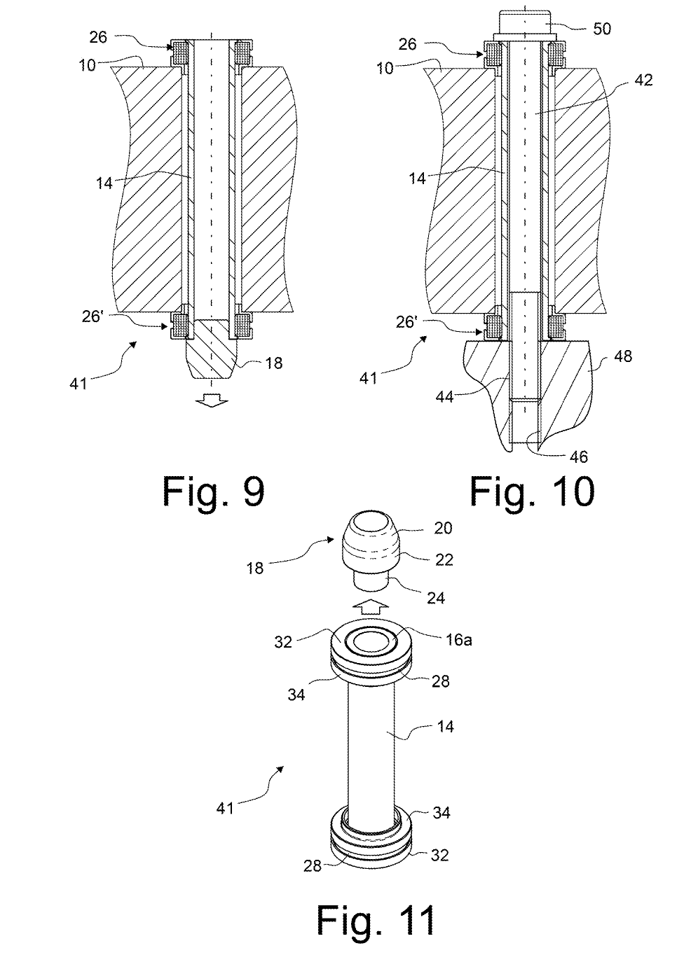

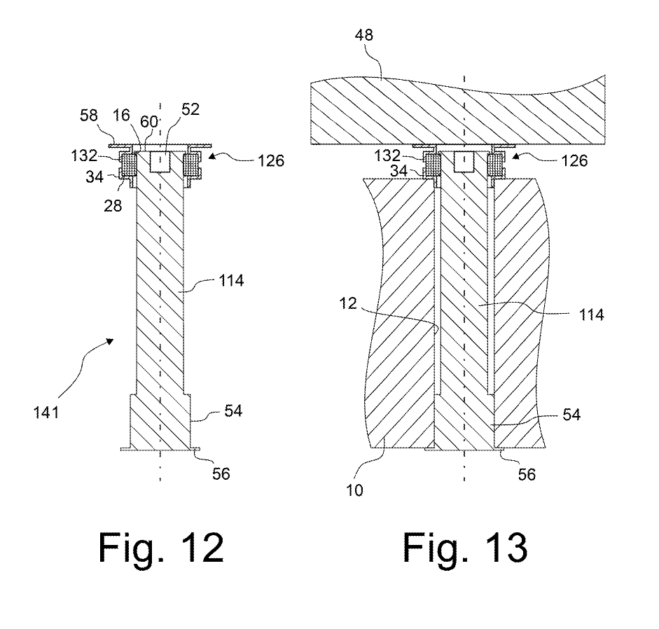

FIGS. 12 and 13 show a damping device 141 according to the invention according to a second embodiment in axial steps before and after the attaching to two components 10, 48.

In contrast to the damping device 41 according to the first embodiment, the damping device 141 shown in FIG. 12 does not have a sleeve as insertion element, but rather a stepped bolt 114 which, on its upwardly facing side, is provided with a blind bore 52 into which the second cylindrical portion 24 of the mounting aid 18 can be pushed with a transition fit having a small excess size.

Located on the opposite side of the stepped bolt 114 is a portion 54 having an enlarged cross section which is bounded on the end side by a wider flange 56. As can be seen in FIG. 13, the outer diameter of the portion 54 is dimensioned in such a manner that the latter can be inserted from below into the through-bore 12 of the flange 10 with a transition fit having a small excess size until the flange 56 of the stepped bolt 114 lies against the flange 10 of the first component.

The damping element 126 is constructed similarly to the previously explained damping element 26. However, in comparison to the holder element 32 of the first embodiment, the upper plate-like holder element 132 is bent over outward twice on its upper side. This forms a wide annular contact surface 58 for the second component 48, said contact surface protruding outward in the axial direction over the end surface 60 of the stepped bolt 114. The all-metal cushion 28 can thereby be compressed for damping vibrations without the second component 48 striking against the end surface of the stepped bolt 114.

In addition, in this embodiment, the opening 37 of the all-metal cushion 28 has an inner diameter D_{G} which is not only smaller than the outer diameter D_{K} of the collar 16, but is also somewhat smaller than the outer diameter of the sleeve 14. As a result, the all-metal cushion also remains compressed in the radial direction after the latching.

The damping element 126 is fastened to the stepped bolt 114 in the same manner as has been explained above in conjunction with the first embodiment with reference to FIGS. 1 to 8. A second damping element is not provided in this embodiment.

The second component 48 is not screwed to the first component, but rather merely supported because of its dead weight on the damping element 126, which serves here as a support. As a result, axial vibrations of the first or the second component 48 are only transmitted in damped form to the other component in each case.

What is claimed is:

1. A system for damping vibrations, the system comprising:
a damping device comprising:
a fastening anchor configured to be fixed to a component, the fastening anchor comprising a rod-shaped insertion anchor and an axial securing element projecting in a radial direction from the insertion element, and
an elastic all-metal cushion comprising an opening dimensioned, in an unexpanded state, such that the axial securing element is not insertable through it; and
an installation aid configured to be releasably fastened to the fastening anchor, wherein the installation aid is shaped such that, when it is fastened to the fastening anchor and the all-metal cushion is pushed over the installation aid, the installation aid expands the opening of the all-metal cushion in the radial direction to such an extent that the opening of the all-metal cushion passes the axial securing element and the all-metal cushion latches behind the axial securing element.

2. The system of claim 1, wherein the insertion element comprises a circumferential surface, and wherein the axial securing element is formed by a step on the circumferential surface.

3. The system of claim 2, wherein the step is located at one end of the insertion element, thereby forming a collar.

4. The system of claim 1, wherein the insertion element is a sleeve.

5. The system of claim 4, wherein the installation aid comprises a cylindrical portion configured to be inserted into the sleeve with a transition fit having a small excess size to releasably fasten the installation aid to the fastening anchor.

6. The system of claim 4, wherein the component is a first component, the system further comprising a fastening element configured to be passed through the sleeve and fastened to a second component.

7. The system of claim 1, wherein the installation aid comprises a portion having a cross section which increases in a longitudinal direction of the installation aid to expand the opening of the all-metal cushion.

8. The system of claim 1, comprising an axial securing element projecting in the radial direction at each end of the insertion element.

9. A damping device for damping vibrations, the device comprising:
a fastening anchor comprising a rod-shaped insertion element and an axial securing element projecting in a radial direction from the insertion element, wherein the fastening anchor is configured to be fixed to a component;
an elastic all-metal cushion comprising an opening dimensioned such that the axial securing element is not insertable through it when the all-metal cushion is in an unexpanded state; and
wherein the opening of the all-metal cushion is configured to be expanded in the radial direction with the aid of an installation aid to such an extent that the opening in the all-metal cushion passes the axial securing element and the all-metal cushion latches behind the axial securing element.

10. A method for attaching a damping device to a component, the method comprising:
providing a damping device comprising:
an elastic all-metal cushion comprising an opening, and
a fastening anchor comprising a rod-shaped insertion element and an axial securing element projecting radially from the rod-shaped insertion element;
releasably fastening an installation aid to a first end of the fastening anchor;
pushing the all-metal cushion with the opening over the installation aid to expand the opening of the all-metal cushion in the radial direction to such an extent that the opening passes the axial securing element and latches the all-metal cushion behind the axial securing element; and
at a time after the providing, inserting the insertion element into a bore in the component, wherein the diameter the bore is smaller than an outer diameter of the all-metal cushion.

11. The method according to claim 10, wherein:
the bore is a through-bore having a length smaller than a length of the insertion element;
the elastic all-metal cushion is a first elastic all-metal cushion; and
the method further comprises repeating the fastening and the pushing after the inserting, wherein the repeated fastening and pushing are performed using a second elastic all-metal cushion at a second end of the fastening anchor lying opposite the first end, as a result of which the component is surrounded by the first and second all-metal cushions.

12. The method according to claim 11, wherein the insertion element is a sleeve, wherein the component is a first component, the method further comprising:
passing a fastening element through the sleeve; and
fastening the fastening element to a second component.
